(19) United States
(12) Patent Application Publication
(10) Pub. No.: US 2024/0332492 A1
(43) Pub. Date: Oct. 3, 2024

(54) METHOD OF MANUFACTURING ALL SOLID-STATE SECONDARY BATTERY

(71) Applicant: HONDA MOTOR CO., LTD., Tokyo (JP)

(72) Inventors: Hiroki Ichihara, Wako-shi (JP); Yohei Noji, Wako-shi (JP); Takashi Toyoshima, Wako-shi (JP); Kosei Miyata, Wako-shi (JP)

(21) Appl. No.: 18/588,002

(22) Filed: Feb. 27, 2024

(30) Foreign Application Priority Data
Mar. 29, 2023 (JP) 2023-052753

(51) Int. Cl. H01M 4/04; H01M 10/058; H01M 50/403

(52) U.S. Cl. CPC H01M 4/0435; H01M 10/058; H01M 50/403

(57) ABSTRACT

A method of manufacturing an all solid-state secondary battery includes a positive electrode layer forming process, an electrolyte layer laminating process, a first compression process, an intermediate layer laminating process, a second compression process, a negative electrode layer laminating process, and a third compression process. A second pressure in the second compression process is higher than each of a first pressure in the first compression process and a third pressure in the third compression process.

### CROSS-REFERENCE TO RELATED APPLICATION

Priority is claimed on Japanese Patent Application No. 2023-052753, filed Mar. 29, 2023, the content of which is incorporated herein by reference.

### BACKGROUND OF THE INVENTION

### Field of the Invention

The present invention relates to a method of manufacturing an all solid-state secondary battery.

### Description of Related Art

In recent years, research and development of secondary batteries that contribute to energy efficiency has been underway to ensure that more people have access to affordable, reliable, sustainable, and advanced energy. Among secondary batteries, all solid-state secondary batteries are attracting attention because of their excellent characteristics in terms of safety, longevity, output, and the like. As a method of manufacturing an all solid-state secondary battery, a method of pressing a laminated body constituted by a positive electrode layer, a solid electrolyte, and a negative electrode layer is known (for example, see Japanese Patent No. 6251974).

### SUMMARY OF THE INVENTION

Incidentally, in technology related to secondary batteries, the challenge is to obtain homogeneity for all solid-state batteries.

An aspect of the present invention is directed to accomplishing a method of manufacturing an all solid-state secondary battery with excellent homogeneity. This contributes to energy efficiency.

An aspect of the present invention provides the following configurations.

A method of manufacturing an all solid-state secondary battery according to an aspect of the present invention includes a positive electrode layer forming process of forming a positive electrode layer containing a positive electrode active material; an electrolyte layer laminating process of laminating an electrolyte layer containing a solid electrolyte on one surface of the positive electrode layer; a first compression process of compressing the positive electrode layer and the electrolyte layer with a first pressure and obtaining a first compressed body; an intermediate layer laminating process of laminating an intermediate layer on a surface of the first compressed body in which the electrolyte layer is exposed; a second compression process of compressing the positive electrode layer, the electrolyte layer, and the intermediate layer with a second pressure and obtaining a second compressed body; a negative electrode layer laminating process of laminating a negative electrode layer on a surface of the second compressed body in which the intermediate layer is exposed; and a third compression process of compressing the positive electrode layer, the electrolyte layer, the intermediate layer, and the negative electrode layer with a third pressure and obtaining a third compressed body. The positive electrode layer forming process, the electrolyte layer laminating process, the first compression process, the intermediate layer laminating process, the second compression process, the negative electrode layer laminating process, and the third compression process are performed in sequence. The second pressure is higher than each of the first pressure and the third pressure.

According to this method, the electrolyte layer is flattened by performing the first compression process. Since the electrolyte layer is flattened, even when the intermediate layer is laminated on the electrolyte layer and the second compression process is performed, it is possible to prevent the electrolyte layer from biting into the intermediate layer.

By performing the second compression process, the positive electrode layer and the intermediate layer are densified. Accordingly, it is possible to prevent the electrolyte layer from biting into the intermediate layer.

By performing the third compression process, strength of the all solid-state secondary battery is improved. For example, in an operating environment of the all solid-state secondary battery, even when repeated loads such as compression and non-compression occur in all solid-state secondary batteries in the surface direction of the electrolyte layer, it is possible to suppress the occurrence of damage due to elongation or cracking in the electrolyte layer.

Further, since smoothness in an interface between the electrolyte layer and the intermediate layer is improved, it is possible to realize the all solid-state secondary battery with excellent homogeneity.

In the method of manufacturing an all solid-state secondary battery according to the aspect of the present invention, in the positive electrode layer forming process, the positive electrode layer may be formed on a positive electrode current collector such that the positive electrode layer is laminated.

According to this method, the first compressed body has the positive electrode current collector, the positive electrode layer, and the electrolyte layer. Even when the first compression process is performed, it is possible to prevent damage to the positive electrode current collector in the first compressed body.

In the method of manufacturing an all solid-state secondary battery according to the aspect of the present invention, the positive electrode current collector may have a first surface and a second surface which is opposite side of the first surface, and in the positive electrode layer forming process, the positive electrode layer may be formed on each of the first surface and the second surface of the positive electrode current collector.

According to this method, the positive electrode layer is formed on the first surface of the positive electrode current collector. Similarly, the positive electrode layer is formed on the second surface of the positive electrode current collector. That is, a structure in which the positive electrode layers are formed on both surfaces of the positive electrode current collector is obtained. In such a structure, even when the first compression process, the second compression process, and the third compression process are performed, a restoring force of the positive electrode layer generated on the first surface and a restoring force of the positive electrode layer generated on the second surface cancel each other out. Accordingly, in the entire all solid-state secondary battery, occurrence of warpage is suppressed. For this reason, flatness of the all solid-state secondary battery can be improved. In particular, in the first compression process, the second compression process, and the third compression process, when the roll press method is used, a difference in frictional coefficient between a surface of a roll and a surface of the laminated body laminated on both surfaces of the positive electrode current collector can be reduced. Accordingly, flatness of the all solid-state secondary battery can be improved.

In the method of manufacturing an all solid-state secondary battery according to the aspect of the present invention, the intermediate layer may have a solid electrolyte, a carbide, and a binder.

In general, the electrolyte layer is formed of a powder. For this reason, in a structure in which the electrolyte layer is directly bonded to the negative electrode layer, a bonding property of the negative electrode layer to the electrolyte layer is low. On the other hand, in the method of manufacturing an all solid-state secondary battery according to the aspect of the present invention, the intermediate layer is interposed between the negative electrode layer and the electrolyte layer, and the intermediate layer has a solid electrolyte, a carbide, and a binder. Accordingly, in comparison with the structure in which the electrolyte layer is directly bonded to the negative electrode layer, in a structure including the intermediate layer, a bonding property of the negative electrode layer to the electrolyte layer can be increased.

In the method of manufacturing an all solid-state secondary battery according to the aspect of the present invention, the negative electrode layer may have a negative electrode-facing surface that faces the intermediate layer, before performing the negative electrode layer laminating process, surface roughening may be performed on the negative electrode-facing surface, and after the surface roughening is performed, the negative electrode layer laminating process may be performed.

According to this method, by performing surface roughening on the negative electrode-facing surface of the negative electrode layer, a fine uneven shape can be formed on the negative electrode-facing surface. In this case, in an interface in which the negative electrode-facing surface and the intermediate layer are in contact with each other, the intermediate layer easily enters the uneven shape of the negative electrode-facing surface. Accordingly, a bonding property between the negative electrode layer and the intermediate layer can be increased.

In the method of manufacturing an all solid-state secondary battery according to the aspect of the present invention, in the surface roughening, a surface roughness of the negative electrode-facing surface may be 20 μm or more.

According to this method, surface roughness in the negative electrode-facing surface of the negative electrode layer can be sufficiently secured. In addition, the negative electrode-facing surface is a surface where deformation is likely to occur. Accordingly, when the negative electrode layer is deformed in the third compression process, stress generated between the negative electrode layer and the intermediate layer can be absorbed, and a cushioning property can be increased. Accordingly, unintentional deformation can be suppressed, and a uniform pressure can be added to a space between the negative electrode layer and the intermediate layer. A bonding property between the negative electrode layer and the intermediate layer can be increased.

In the method of manufacturing an all solid-state secondary battery according to the aspect of the present invention, in each of the first compression process, the second compression process, and the third compression process, a compression member configured to compress a compression object may be used, and in at least one of the first compression process, the second compression process, and the third compression process, in a state in which a protective sheet is interposed between the compression object and the compression member, the compression member may compress the compression object.

According to this configuration, at least one of the first compression process, the second compression process, and the third compression process is performed using the protective sheet. Accordingly, even when a pressure is applied to a layer that constitutes the all solid-state secondary battery, damage to the layer can be suppressed. Here, the layer that constitutes the all solid-state secondary battery is, for example, the positive electrode current collector, the negative electrode layer, or the like. In particular, when the layer that constitutes the all solid-state secondary battery is formed of a thin foil-shaped material, damage to the layer can be suppressed.

In the method of manufacturing an all solid-state secondary battery according to the aspect of the present invention, after the third compression process is performed, a negative electrode current collector laminating process of laminating a negative electrode current collector on a surface of the third compressed body in which the negative electrode layer is exposed, and a fourth compression process of compressing the positive electrode layer, the electrolyte layer, the intermediate layer, the negative electrode layer, and the negative electrode current collector and obtaining the all solid-state secondary battery may be provided.

According to this method, a structure in which the negative electrode current collector is laminated on the negative electrode layer can be obtained.

In the method of manufacturing an all solid-state secondary battery according to the aspect of the present invention, in the fourth compression process, a compression member configured to compress a compression object may be used, and in the fourth compression process, in a state in which a protective sheet is interposed between the compression object and the compression member, the compression member may compress the compression object.

According to this method, the fourth compression process is performed using the protective sheet. Accordingly, even when a pressure is applied to the negative electrode current collector that constitutes the all solid-state secondary battery, damage to the negative electrode current collector can be suppressed. In particular, when the negative electrode current collector is formed of a thin foil-shaped material, damage to the negative electrode current collector can be suppressed.

According to the method of manufacturing an all solid-state secondary battery of the aspect of the present invention, it is possible to provide a method of manufacturing an all solid-state secondary battery with excellent homogeneity.

### BRIEF DESCRIPTION OF THE DRAWINGS

FIG. 1 is a cross-sectional view partially showing a structure of an all solid-state secondary battery according to a first embodiment of the present invention.

FIG. 2 is a cross-sectional view showing a part of a roll press apparatus, describing a roll press method used in manufacturing the all solid-state secondary battery according to the first embodiment of the present invention.

FIG. 3 is a cross-sectional view partially showing a structure of a first compressed body obtained in the middle of the manufacture, describing a method of manufacturing the all solid-state secondary battery according to the first embodiment of the present invention.

FIG. 4 is a cross-sectional view partially showing a structure of a second compressed body obtained in the middle of the manufacture, describing the method of manufacturing the all solid-state secondary battery according to the first embodiment of the present invention.

FIG. 5 is a cross-sectional view partially showing a structure of a third compressed body obtained in the middle of the manufacture, describing the method of manufacturing the all solid-state secondary battery according to the first embodiment of the present invention.

FIG. 6 is a cross-sectional view showing a part of a roll press apparatus, describing a roll press method used in manufacturing an all solid-state secondary battery according to a fourth embodiment of the present invention.

### DETAILED DESCRIPTION OF THE INVENTION

A method of manufacturing an all solid-state secondary battery according to an embodiment of the present invention will be described with reference to the accompanying drawings.

In the drawings used in the following description, in order to make each member recognizable, the scale of each member is changed as appropriate.

The meaning of the word “lamination” is not limited to forming a layer on an object member, but includes pre-forming a layer and transferring the layer onto an object member.

### First Embodiment

### <Configuration of all Solid-State Secondary Battery>

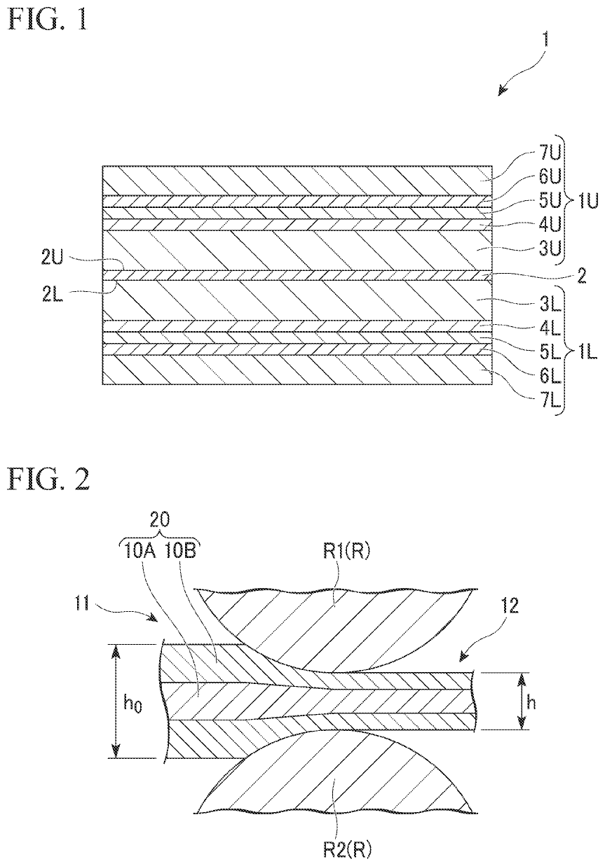

As shown in FIG. 1, an all solid-state secondary battery 1 has a positive electrode current collector 2, positive electrode layers 3U and 3L, electrolyte layers 4U and 4L, intermediate layers 5U and 5L, negative electrode layers 6U and 6L, and negative electrode current collectors 7U and 7L.

The positive electrode current collector 2 has a first surface 2U, and a second surface 2L opposite to the first surface 2U.

In a direction from the positive electrode current collector 2 toward the negative electrode current collector 7U, the positive electrode layer 3U, the electrolyte layer 4U, the intermediate layer 5U, the negative electrode layer 6U, and the negative electrode current collector 7U are laminated on the first surface 2U in sequence. The positive electrode layer 3U, the electrolyte layer 4U, the intermediate layer 5U, the negative electrode layer 6U, and the negative electrode current collector 7U are compressed against the positive electrode current collector 2 to configure a lamination compression structure 1U.

In a direction from the positive electrode current collector 2 toward the negative electrode current collector 7L, the positive electrode layer 3L, the electrolyte layer 4L, the intermediate layer 5L, the negative electrode layer 6L, and the negative electrode current collector 7L are laminated on the second surface 2L in sequence. The positive electrode layer 3L, the electrolyte layer 4L, the intermediate layer 5L, the negative electrode layer 6L, and the negative electrode current collector 7L are compressed against the positive electrode current collector 2 to configure a lamination compression structure 1L.

### <Positive Electrode Current Collector>

The positive electrode current collector 2 is a layer that is in contact with the positive electrode layers 3U and 3L. A material that configures the positive electrode current collector 2 is not particularly limited, and a known material usable as a positive electrode current collector of a solid secondary battery can be used in the positive electrode current collector 2. As the positive electrode current collector 2, for example, a metal foil such as a stainless steel (SUS) foil, an aluminum (Al) foil, or the like is exemplified.

### <Positive Electrode Layer>

The positive electrode layers 3U and 3L are layers that are in contact with the electrolyte layers 4U and 4L, respectively. Each of the positive electrode layers 3U and 3L is a layer containing a positive electrode active material. The positive electrode active material is not particularly limited and a known material may be used as the positive electrode active material of the solid secondary battery. As the positive electrode active material, for example, a ternary system positive electrode material such as LiCoO₂, LiNiO₂, NCM (Li(NiₓCo_{y}Mn_{z})O₂, (0<x<1, 0<y<1, 0<z<1, x+y+z=1)), or the like, a layered positive electrode active material particle such as LiVO₂, LiCrO₂, or the like, a spinel type positive electrode active material such as LiMn₂O₄, Li(Ni_{0.25}Mn_{0.75})₂O₄, LiCoMnO₄, Li₂NiMn₃O₈, or the like, or an olivine type positive electrode active material such as LiCoPO₄, LiMnPO₄, LiFePO₄, or the like may be used.

Each of the positive electrode layers 3U and 3L may further contain a solid electrolyte, a conductive assistant, a binder, or the like, in addition to the positive electrode active material. The solid electrolyte, the conductive assistant, the binder, or the like is not particularly limited and known materials can be applied as the electrode material of the solid secondary battery. The adhesive agent layer may be laminated on outer surfaces of the positive electrode layers 3U and 3L.

### <Electrolyte Layer>

The electrolyte layers 4U and 4L are layers that are in contact with the intermediate layers 5U and 5L, respectively. Each of the electrolyte layers 4U and 4L is a layer containing solid electrolyte. The electrolyte layers 4U and 4L may contain binder or the like, in addition thereto.

The Type of the Solid Electrolyte is not Particularly Limited, and Sulfide-Based solid electrolyte, oxide-based solid electrolyte, nitride-based solid electrolyte, halide-based solid electrolyte, or the like, is exemplified as the solid electrolyte.

A material of the binder is not particularly limited, and, for example, polyvinylidene fluoride (PVdF), polymethyl methacrylate (PMMA), polyisobutene (PIB), styrene butadiene rubber (SBR), polyethylene-vinyl acetate copolymer (PEVA), nitrile rubber (NBR), hydrogenated nitrile rubber (HNBR), or the like, may be exemplified as the material of the binder. These may be used alone or in combination of two or more.

### <Intermediate Layer>

The intermediate layers 5U and 5L are layers that are in contact with the negative electrode layers 6U and 6L, respectively. As a material of the intermediate layers 5U and 5L, for example, a solid electrolyte, a carbide, and a binder are exemplified. As the carbide, for example, SnC may be used.

The intermediate layer 5U has at least one of a function of increasing ion conductivity between the electrolyte layer 4U and the negative electrode layer 6U corresponding to each other, and a function of protecting a surface of the negative electrode layer 6U.

Similarly, the intermediate layer 5L has at least one of a function of increasing ion conductivity between the electrolyte layer 4L and the negative electrode layer 6L corresponding to each other, and a function of protecting a surface of the negative electrode layer 6L.

### <Negative Electrode Layer>

The negative electrode layers 6U and 6L are layers that are in contact with the negative electrode current collectors 7U and 7L, respectively. Each of the negative electrode layers 6U and 6L is a layer containing a negative electrode active material. The negative electrode active material is not particularly limited, and a known material may be used as the negative electrode active material of the solid secondary battery. As the negative electrode active material, for example, lithium transition metal oxide such as lithium titanate (Li₄Ti₅O₁₂) or the like, transition metal oxide such as TiO₂, Nb₂O₃, WO₃, or the like, metal sulfide, metal nitride, a carbon material such as, graphite, soft carbon, hard carbon, or the like, a silicon-based material such as silicon single substance, silicon alloy, silicon compound, or the like, and lithium metal, lithium alloy, metal indium, or the like are exemplified.

Each of the negative electrode layers 6U and 6L may further include a solid electrolyte, a conductive assistant, a binder, or the like, in addition to the negative electrode active material. The solid electrolyte, the conductive assistant, the binder, or the like, is not particularly limited, and a known material may be applied as the electrode material of the solid secondary battery.

### <Negative Electrode Current Collector>

Each of the negative electrode current collectors 7U and 7L corresponds to the outermost layer of the all solid-state secondary battery 1. In other words, the negative electrode current collector 7U corresponds to the outermost layer of the lamination compression structure 1U. The negative electrode current collector 7L corresponds to the outermost layer of the lamination compression structure 1L.

A material of the negative electrode current collectors 7U and 7L is not particularly limited, and a known material may be used as the negative electrode current collector of the solid secondary battery. As the negative electrode current collector, metal foil such as copper (Cu) foil, stainless steel (SUS) foil, aluminum (Al) foil, or the like, is exemplified.

### <Method of Manufacturing all Solid-State Secondary Battery According to First Embodiment>

Next, the method of manufacturing the all solid-state secondary battery 1 according to the first embodiment will be described with reference to FIG. 1 to FIG. 5.

The method of manufacturing the all solid-state secondary battery 1 has the following processes.
Step 1: Positive electrode layer forming process
Step 2: Electrolyte layer laminating process
Step 3: First compression process
Step 4: Intermediate layer laminating process
Step 5: Second compression process
Step 6: Negative electrode layer laminating process
Step 7: Third compression process
Step 8: Negative electrode current collector laminating process
Step 9: Fourth compression process

Further, in the method of manufacturing the all solid-state secondary battery 1, steps 1 to 9 are performed in sequence. Further, in the first compression process, the second compression process, the third compression process, and the fourth compression process, a known compression process is performed. As an example of the compression process, in the embodiment, a roll press method is employed.

### <Roll Press Apparatus>

FIG. 2 is a cross-sectional view showing a part of a roll press apparatus configured to perform a roll press method.

The roll press apparatus has a first roll R1 and a second roll R2, which face each other, and a delivery mechanism (not shown). The first roll R1 is rotatable counterclockwise. The second roll R2 is rotatable clockwise. The delivery mechanism can send a compression object 20 to a gap between the first roll R1 and the second roll R2 in a direction from an insertion portion 11 toward a discharge portion 12. A distance between the first roll R1 and the second roll R2 can be adjusted as appropriate. In addition, the roll press apparatus can adjust a compressive force added to the compression object 20 as appropriate. In the following description, when the first roll R1 and the second roll R2 are not discriminated, the first roll R1 and the second roll R2 may be simply referred to as “a roll R.”

Each of the first roll R1 and the second roll R2 is an example of a compression member configured to compress a compression object.

### <Roll Press Method>

The compression object 20 is a laminated body having a first layer 10A and a second layer 10B. In a state before compression, the compression object 20 has a thickness h0. First, the delivery mechanism sends the compression object 20 to a gap between the first roll R1 and the second roll R2 through the insertion portion 11. According to rotation of the first roll R1 and the second roll R2, the compression object 20 moves from the insertion portion 11 toward the discharge portion 12. The compression object 20 is compressed by the first roll R1 and the second roll R2, and a thickness of the compression object 20 is gradually reduced. A thickness of each of the first layer 10A and the second layer 10B that constitute the compression object 20 is gradually reduced. In a state after compression, the compression object 20 has a thickness h smaller than the thickness h0.

Next, each of steps 1 to 9 will be described.

### <Step 1: Positive Electrode Layer Forming Process>

First, the positive electrode current collector 2, and the positive electrode layers 3U and 3L are prepared.

Next, the positive electrode layer 3U is laminated on the first surface 2U of the positive electrode current collector 2. The positive electrode layer 3L is laminated on the second surface 2L of the positive electrode current collector 2. Accordingly, a laminated body is obtained by laminating the positive electrode current collector 2 and the positive electrode layers 3U and 3L.

### <Step 2: Electrolyte Layer Laminating Process>

Next, the electrolyte layers 4U and 4L are prepared.

Next, the electrolyte layer 4U is laminated on the positive electrode layer 3U. The electrolyte layer 4L is laminated on the positive electrode layer 3L. Accordingly, a laminated body is obtained by laminating the positive electrode current collector 2, the positive electrode layers 3U and 3L, and the electrolyte layers 4U and 4L.

Further, in the electrolyte layer laminating process, a method of transferring the electrolyte layers 4U and 4L, which are separately formed, to the positive electrode layers 3U and 3L may be employed in advance, without directly forming the electrolyte layers 4U and 4L on the positive electrode layers 3U and 3L.

### <Step 3: First Compression Process>

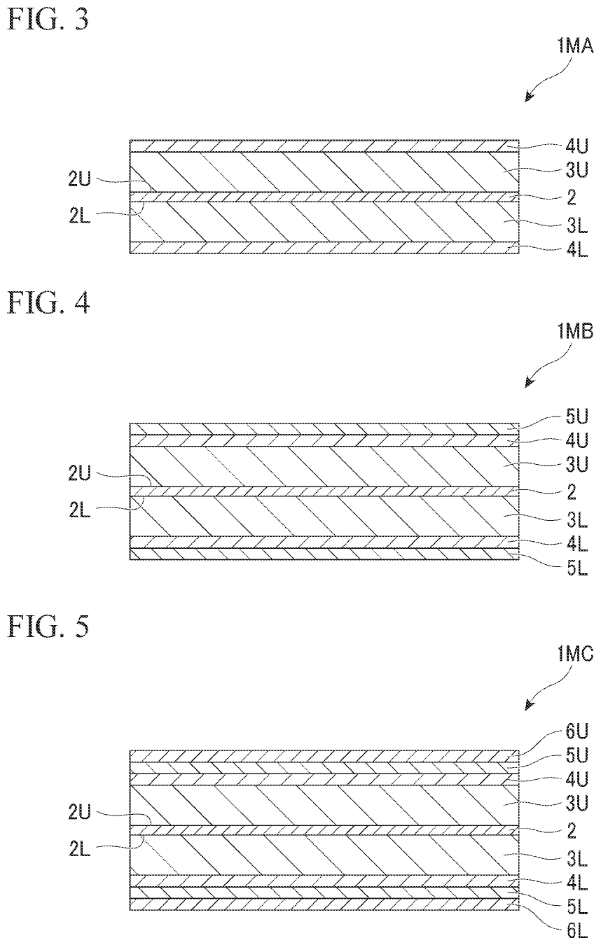

Next, the laminated body obtained by the electrolyte layer laminating process is compressed using the roll press apparatus shown in FIG. 2. Specifically, as the compression object 20, the laminated body obtained by the electrolyte layer laminating process is inserted between the first roll R1 and the second roll R2. According to rotation of the first roll R1 and the second roll R2, the laminated body is gradually compressed. Accordingly, a first compressed body 1MA shown in FIG. 3 is obtained. In the first compression process, a pressure (first pressure) applied to the laminated body by the first roll R1 and the second roll R2 is, for example, 300 MPa to 500 MPa.

### <Step 4: Intermediate Layer Laminating Process>

Next, the intermediate layers 5U and 5L are prepared.

Next, the intermediate layer 5U is laminated on a surface of the first compressed body 1MA in which the electrolyte layer 4U is exposed. The intermediate layer 5L is laminated on a surface of the first compressed body 1MA in which the electrolyte layer 4L is exposed. Accordingly, a laminated body is obtained by laminating the positive electrode current collector 2, the positive electrode layers 3U and 3L, the electrolyte layers 4U and 4L, and the intermediate layers 5U and 5L.

### <Step 5: Second Compression Process>

Next, the laminated body obtained by the intermediate layer laminating process is compressed using the roll press apparatus shown in FIG. 2. Specifically, as the compression object 20, the laminated body obtained by the intermediate layer laminating process is inserted between the first roll R1 and the second roll R2. According to rotation of the first roll R1 and the second roll R2, the laminated body is gradually compressed. Accordingly, a second compressed body 1MB shown in FIG. 4 is obtained. In the second compression process, a pressure (second pressure) applied to the laminated body by the first roll R1 and the second roll R2 is, for example, 700 MPa or more. Accordingly, in comparison of the first pressure and the second pressure, the second pressure is set to be higher than the first pressure.

### <Step 6: Negative Electrode Layer Laminating Process>

Next, the negative electrode layers 6U and 6L are prepared.

Next, the negative electrode layer 6U is laminated on a surface of the second compressed body 1MB in which the intermediate layer 5U is exposed. The negative electrode layer 6L is laminated on a surface of the second compressed body 1MB in which the intermediate layer 5L is exposed. Accordingly, a laminated body is obtained by laminating the positive electrode current collector 2, the positive electrode layers 3U and 3L, the electrolyte layers 4U and 4L, the intermediate layers 5U and 5L, and the negative electrode layers 6U and 6L.

### <Step 7: Third Compression Process>

Next, the laminated body obtained by the negative electrode layer laminating process is compressed using the roll press apparatus shown in FIG. 2. Specifically, as the compression object 20, the laminated body obtained by the negative electrode layer laminating process is inserted between the first roll R1 and the second roll R2. According to rotation of the first roll R1 and the second roll R2, the laminated body is gradually compressed. Accordingly, a third compressed body 1MC shown in FIG. 5 is obtained. In the third compression process, a pressure (third pressure) applied to the laminated body by the first roll R1 and the second roll R2 is, for example, 400 MPa or less. Accordingly, in comparison of the second pressure and the third pressure, the second pressure is set to be higher than the third pressure. More preferably, in comparison of the first pressure, the second pressure, and the third pressure, the second pressure is set to be higher than the third pressure, and the first pressure is set to be higher than the third pressure.

### <Step 8: Negative Electrode Current Collector Laminating Process>

Next, the negative electrode current collectors 7U and 7L are prepared.

Next, the negative electrode current collector 7U is laminated on a surface of the third compressed body 1MC in which the negative electrode layer 6U is exposed. The negative electrode current collector 7L is laminated on a surface of the third compressed body 1MC in which the negative electrode layer 6L is exposed. Accordingly, a laminated body is obtained by laminating the positive electrode current collector 2, the positive electrode layers 3U and 3L, the electrolyte layers 4U and 4L, the intermediate layers 5U and 5L, the negative electrode current collectors 7U and 7L, and the negative electrode current collectors 7U and 7L.

### <Step 9: Fourth Compression Process>

Next, the laminated body obtained by the negative electrode current collector laminating process is compressed using the roll press apparatus shown in FIG. 2. Specifically, as the compression object 20, the laminated body obtained by the negative electrode current collector laminating process is inserted between the first roll R1 and the second roll R2. According to rotation of the first roll R1 and the second roll R2, the laminated body is gradually compressed. Accordingly, the all solid-state secondary battery 1 shown in FIG. 1 is obtained.

### <Effects>

According to the above-mentioned method, each of the electrolyte layers 4U and 4L is flattened by performing the first compression process. Since each of the electrolyte layers 4U and 4L is flattened, even when a second compression process is performed by laminating the intermediate layers 5U and 5L on the electrolyte layers 4U and 4L, respectively, it is possible to prevent the electrolyte layer 4U from biting into the intermediate layer 5U, and prevent the electrolyte layer 4L from biting into the intermediate layer 5L.

The positive electrode layers 3U and 3L and the intermediate layers 5U and 5L are densified by performing the second compression process. Accordingly, it is possible to prevent the electrolyte layer 4U from biting into the intermediate layer 5U, and prevent the electrolyte layer 4L from biting into the intermediate layer 5L.

Strength of the all solid-state secondary battery 1 is improved by performing the third compression process. For example, in an operating environment of the all solid-state secondary battery 1, even if repeated loads such as compression and non-compression occur on the all solid-state secondary battery 1 in the surface direction of the electrolyte layers 4U and 4L, occurrence of damage due to elongation or cracking in the electrolyte layers 4U and 4L is suppressed.

Further, since smoothness in an interface between the electrolyte layer 4U and the intermediate layer 5U is improved and smoothness in an interface between the electrolyte layer 4L and the intermediate layer 5L is improved, it is possible to realize the all solid-state secondary battery 1 with excellent homogeneity.

Further, the first compressed body 1MA has the positive electrode current collector 2, the positive electrode layers 3U and 3L, and the electrolyte layers 4U and 4L. Damage to the positive electrode current collector 2 in the first compressed body 1MA can be suppressed even when the first compression process is performed.

Further, the positive electrode layer 3U is formed on the first surface 2U of the positive electrode current collector 2. Similarly, the positive electrode layer 3L is formed on the second surface 2L of the positive electrode current collector 2. That is, a structure in which the positive electrode layers 3U and 3L are formed on both surfaces of the positive electrode current collector 2 is obtained. In such a structure, even after the first compression process, the second compression process, and the third compression process are performed, the restoring force of the positive electrode layer 3U generated in the first surface 2U and the restoring force of the positive electrode layer 3L generated in the second surface 2L cancel each other out. Accordingly, occurrence of warpage is suppressed throughout the all solid-state secondary battery 1. For this reason, flatness of the all solid-state secondary battery 1 can be improved. In particular, in the first compression process, the second compression process, and the third compression process, when the roll press method is used, a difference in frictional coefficient between the surface of the roll R and the surface of the laminated body laminated on both surfaces of the positive electrode current collector 2 can be reduced. Accordingly, flatness of the all solid-state secondary battery 1 can be improved.

In general, the electrolyte layer is composed of powder. For this reason, in the structure configured to directly bond the electrolyte layer to the negative electrode layer, a bonding property of the negative electrode layer with respect to the electrolyte layer is low. On the other hand, according to the embodiment, the intermediate layer 5U is interposed between the negative electrode layer 6U and the electrolyte layer 4U. Further, the intermediate layer 5L is interposed between the negative electrode layer 6L and the electrolyte layer 4L. In addition, each of the intermediate layers 5U and 5L has a solid electrolyte, a carbide, and a binder.

Accordingly, in comparison with the structure in which the electrolyte layer is directly bonded to the negative electrode layer, in the structure including the intermediate layers 5U and 5L, a bonding property of the negative electrode layer 6U to the electrolyte layer 4U can be increased, and a bonding property of the negative electrode layer 6L to the electrolyte layer 4L can be increased.

Further, since the negative electrode current collector laminating process and the fourth compression process are performed, a structure in which the negative electrode current collectors 7U and 7L are laminated on the negative electrode layers 6U and 6L, respectively, can be obtained.

### Second Embodiment

Next, an all solid-state secondary battery 1 according to a second embodiment will be described.

The second embodiment is distinguished from the first embodiment in configurations of the negative electrode layers 6U and 6L.

In the second embodiment, the same members as in the first embodiment are designated by the same reference signs, and descriptions thereof will be omitted or simplified.

### <Negative Electrode Layer>

In the second embodiment, the negative electrode layer 6U has a negative electrode-facing surface that faces the intermediate layer 5U. The negative electrode layer 6L has a negative electrode-facing surface that faces the intermediate layer 5L.

### <Method of Manufacturing all Solid-State Secondary Battery According to Second Embodiment>

First, like the first embodiment, the above-mentioned steps 1 to 5 are performed.

Next, before performing the negative electrode layer laminating process of step 6, surface roughening is performed on the negative electrode-facing surface of each of the negative electrode layers 6U and 6L. In the surface roughening, a surface roughness of the negative electrode-facing surface is 20 μm or more.

After performing the surface roughening, like the first embodiment, the above-mentioned steps 6 to 9 are performed.

### <Effects>

According to this method, by performing the surface roughening on the negative electrode-facing surfaces of the negative electrode layers 6U and 6L, fine uneven shapes are formed on the negative electrode-facing surfaces. In this case, in an interface in which the negative electrode-facing surfaces are in contact with the intermediate layers 5U and 5L, the intermediate layers 5U and 5L easily fit into the uneven shapes of the negative electrode-facing surfaces. Accordingly, a bonding property between the negative electrode layer 6U and the intermediate layer 5U can be increased, and a bonding property between the negative electrode layer 6L and the intermediate layer 5L can be increased.

Further, by setting the surface roughness of the negative electrode-facing surface to 20 μm or more, the surface roughness in the negative electrode-facing surfaces of the negative electrode layers 6U and 6L can be sufficiently secured. In addition, the negative electrode-facing surface is a surface where deformation is likely to occur. Accordingly, when the negative electrode layers 6U and 6L are deformed in the third compression process, stress generated between the negative electrode layer 6U and the intermediate layer 5U is absorbed, and stress generated between the negative electrode layer 6L and the intermediate layer 5L is absorbed. Accordingly, cushioning properties can be increased. Accordingly, unintentional deformation can be suppressed, a uniform pressure can be applied to a space between the negative electrode layer 6U and the intermediate layer 5U, and a uniform pressure can be applied to a space between the negative electrode layer 6L and the intermediate layer 5L. A bonding property between the negative electrode layer 6U and the intermediate layer 5U can be increased, and a bonding property between the negative electrode layer 6L and the intermediate layer 5L can be increased.

### Third Embodiment

Next, an all solid-state secondary battery 1 according to a third embodiment will be described.

The third embodiment is distinguished from the first embodiment in the configurations of the negative electrode layers 6U and 6L and the negative electrode current collectors 7U and 7L.

In the third embodiment, the same members as in the first embodiment are designated by the same reference signs, and descriptions thereof will be omitted or simplified.

### <Negative Electrode Layer>

In the third embodiment, each of the negative electrode layers 6U and 6L includes both a function of the negative electrode layer and a function of the negative electrode current collector. Each of the negative electrode layers 6U and 6L corresponds to the outermost layer of the all solid-state secondary battery 1. In other words, the negative electrode layer 6U corresponds to the outermost layer of the lamination compression structure 1U. The negative electrode layer 6L corresponds to the outermost layer of the lamination compression structure 1L.

Each of the negative electrode layers 6U and 6L has a structure in which the negative electrode active material layer and the negative electrode current collecting layer are laminated. The negative electrode active material layer includes the negative electrode active material described in the first embodiment. The negative electrode current collecting layer is a metal foil such as a copper (Cu) foil, a stainless steel (SUS) foil, an aluminum (Al) foil, or the like.

### <Method of Manufacturing all Solid-State Secondary Battery According to Third Embodiment>

First, like the first embodiment, the above-mentioned steps 1 to 6 are performed.

In the negative electrode layer laminating process of step 6, the negative electrode layer 6U that is the laminated body of the negative electrode active material layer and the negative electrode current collecting layer is laminated on the surface of the second compressed body 1MB in which the intermediate layer 5U is exposed. Similarly, the negative electrode layer 6L that is the laminated body of the negative electrode active material layer and the negative electrode current collecting layer is laminated on the surface of the second compressed body 1MB in which the intermediate layer 5L is exposed.

Next, the above-mentioned step 7 is performed. The third compressed body obtained by step 7 is the all solid-state secondary battery 1 shown in FIG. 1.

### <Effects>

According to this method, each of the negative electrode layers 6U and 6L is the laminated body of the negative electrode active material layer and the negative electrode current collecting layer. For this reason, there is no need to prepare the negative electrode current collectors 7U and 7L described in step 8, and there is also no need to compress the laminated body including the negative electrode current collectors 7U and 7L described in step 9. Accordingly, the number of processings for manufacturing the all solid-state secondary battery 1 can be reduced.

### Fourth Embodiment

Next, a method of manufacturing an all solid-state secondary battery according to a fourth embodiment will be described.

The fourth embodiment is distinguished from each of the above-mentioned first to third embodiments in that a protective sheet is interposed between the compression object 20 and the roll R.

In the fourth embodiment, the same members as in the first to third embodiments are designated by the same reference signs, and descriptions thereof will be omitted or simplified.

### <Protective Sheet>

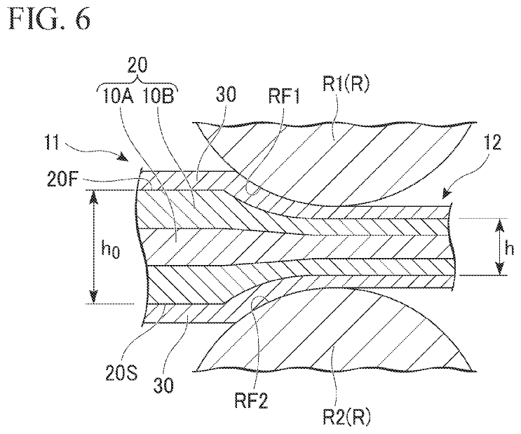

In at least one of the first compression process, the second compression process, the third compression process, and the fourth compression process, as shown in FIG. 6, a protective sheet 30 is interposed between the compression object 20 and the first roll R1. In other words, the protective sheet 30 is interposed between a first compression surface RF1 of the first roll R1 and a first compression object surface 20F of the compression object 20. Similarly, the protective sheet 30 is interposed between the compression object 20 and the second roll R2. In other words, the protective sheet 30 is interposed between a second compression surface RF2 of the second roll R2 and a second compression object surface 20S of the compression object 20.

In this state, the first roll R1 and the second roll R2 compress the compression object 20 while rotating.

In the method of manufacturing an all solid-state secondary battery according to the above-mentioned embodiment, the protective sheet 30 can be interposed between the positive electrode current collector 2 and the roll R. The protective sheet 30 can be interposed between each of the negative electrode layers 6U and 6L and the roll R. In addition, the protective sheet 30 can be interposed between each of the negative electrode current collectors 7U and 7L and the roll R.

The protective sheet 30 is separate from each of the positive electrode current collector 2, the negative electrode layers 6U and 6L, and the negative electrode current collectors 7U and 7L. In other words, the protective sheet 30 is a member that does not constitute the all solid-state secondary battery. For this reason, the protective sheet 30 is removed from the compression object 20 after each of the plurality of compression processes is terminated. Further, the protective sheet 30 may remain covering the compression object 20 until the next compression process is performed after one compression process is terminated.

Further, in the example shown in FIG. 6, while the protective sheets 30 are disposed on both surfaces of the compression object 20, the protective sheet 30 may be disposed at least one surface of the compression object 20.

As the material of the protective sheet 30, for example, a metal foil or a resin film is employed. As the metal foil, for example, a copper (Cu) foil, a stainless steel (SUS) foil, an aluminum (Al) foil, or the like, is exemplified. As the resin film, polyimide, polyether imide, fluororesin, or the like, is exemplified. A thickness of the protective sheet 30 is within a range of, for example, 5 to 150 μm.

### <Effects>

According to this method, the same or similar effects as those obtained by the above-mentioned embodiment are obtained. In at least one of the first compression process, the second compression process, the third compression process, and the fourth compression process, even when the pressure is added to the positive electrode current collector 2, the negative electrode layers 6U and 6L, and the negative electrode current collectors 7U and 7L, since the protective sheet 30 is used, damage to the positive electrode current collector 2, the negative electrode layers 6U and 6L, and the negative electrode current collectors 7U and 7L can be suppressed.

In particular, when the positive electrode current collector 2, the negative electrode layers 6U and 6L, and the negative electrode current collectors 7U and 7L are formed of a thin foil-shaped material, it is possible to obtain an effect of suppressing damage to the positive electrode current collector 2, the negative electrode layers 6U and 6L, and the negative electrode current collectors 7U and 7L.

### <Variant>

In the above-mentioned embodiment, the case in which the lamination compression structures 1U and 1L are formed on the first surface 2U and the second surface 2L of the positive electrode current collector 2, respectively, has been described. The lamination compression structure may be formed on only one surface of the positive electrode current collector 2.

In the above-mentioned embodiment, the case in which the roll press method is used as an example of the compression process has been described. A compression method other than the roll press method may be employed as long as the compression object 20 can be compressed using the compression member.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A method of manufacturing an all solid-state secondary battery, the method comprising:
a positive electrode layer forming process of forming a positive electrode layer containing a positive electrode active material;
an electrolyte layer laminating process of laminating an electrolyte layer containing a solid electrolyte on one surface of the positive electrode layer;
a first compression process of compressing the positive electrode layer and the electrolyte layer with a first pressure and obtaining a first compressed body;
an intermediate layer laminating process of laminating an intermediate layer on a surface of the first compressed body in which the electrolyte layer is exposed;
a second compression process of compressing the positive electrode layer, the electrolyte layer, and the intermediate layer with a second pressure and obtaining a second compressed body;
a negative electrode layer laminating process of laminating a negative electrode layer on a surface of the second compressed body in which the intermediate layer is exposed; and
a third compression process of compressing the positive electrode layer, the electrolyte layer, the intermediate layer, and the negative electrode layer with a third pressure and obtaining a third compressed body,
wherein the positive electrode layer forming process, the electrolyte layer laminating process, the first compression process, the intermediate layer laminating process, the second compression process, the negative electrode layer laminating process, and the third compression process are performed in sequence, and the second pressure is higher than each of the first pressure and the third pressure.

2. The method of manufacturing an all solid-state secondary battery according to claim 1, wherein, in the positive electrode layer forming process, the positive electrode layer is formed on a positive electrode current collector such that the positive electrode layer is laminated.

3. The method of manufacturing an all solid-state secondary battery according to claim 2, wherein the positive electrode current collector has a first surface and a second surface at opposite side of the first surface, and
in the positive electrode layer forming process, the positive electrode layer is formed on each of the first surface and the second surface of the positive electrode current collector.

4. The method of manufacturing an all solid-state secondary battery according to claim 1, wherein the intermediate layer has a solid electrolyte, a carbide, and a binder.

5. The method of manufacturing an all solid-state secondary battery according to claim 1, wherein the negative electrode layer has a negative electrode-facing surface that faces the intermediate layer,
before performing the negative electrode layer laminating process, surface roughening is performed on the negative electrode-facing surface, and
after the surface roughening is performed, the negative electrode layer laminating process is performed.

6. The method of manufacturing an all solid-state secondary battery according to claim 5, wherein, in the surface roughening, a surface roughness of the negative electrode-facing surface is 20 μm or more.

7. The method of manufacturing an all solid-state secondary battery according to claim 1, wherein, in each of the first compression process, the second compression process, and the third compression process, a compression member configured to compress a compression object is used, and
in at least one of the first compression process, the second compression process, and the third compression process, in a state in which a protective sheet is interposed between the compression object and the compression member, the compression member compresses the compression object.

8. The method of manufacturing an all solid-state secondary battery according to claim 2, wherein, in each of the first compression process, the second compression process, and the third compression process, a compression member configured to compress a compression object is used, and
in at least one of the first compression process, the second compression process, and the third compression process, in a state in which a protective sheet is interposed between the compression object and the compression member, the compression member compresses the compression object.

9. The method of manufacturing an all solid-state secondary battery according to claim 3, wherein, in each of the first compression process, the second compression process, and the third compression process, a compression member configured to compress a compression object is used, and
in at least one of the first compression process, the second compression process, and the third compression process, in a state in which a protective sheet is interposed between the compression object and the compression member, the compression member compresses the compression object.

10. The method of manufacturing an all solid-state secondary battery according to claim 1, comprising: after the third compression process,
a negative electrode current collector laminating process of laminating a negative electrode current collector on a surface of the third compressed body in which the negative electrode layer is exposed, and
a fourth compression process of compressing the positive electrode layer, the electrolyte layer, the intermediate layer, the negative electrode layer, and the negative electrode current collector and obtaining the all solid-state secondary battery.

11. The method of manufacturing an all solid-state secondary battery according to claim 10, wherein, in the fourth compression process, a compression member configured to compress a compression object is used, and
in the fourth compression process, in a state in which a protective sheet is interposed between the compression object and the compression member, the compression member compresses the compression object.
